(19) United States
(12) Patent Application Publication
(10) Pub. No.: US 2023/0214581 A1
(43) Pub. Date: Jul. 6, 2023

(54) SYSTEMS AND METHODS FOR QUANTUM COMPUTING-BASED EXTRACTIVE SUMMARIZATION

(71) Applicant: JPMORGAN CHASE BANK , N.A., New York, NY (US)

(72) Inventors: Pradeep NIROULA, College Park, MD (US); Romina YALOVETZKY, Buenos Aires (AR); Pierre MINSSEN, New York, NY (US); Dylan HERMAN, Woodcliff Lake, NJ (US); Marco PISTOIA, Amawalk, NY (US); Shaohan HU, Yorktown Heights, NY (US)

(21) Appl. No.: 17/647,311

(22) Filed: Jan. 6, 2022

(51) Int. Cl. G06F 40/166; G06N 10/20; G06N 10/60; G06F 40/242

(52) U.S. Cl. CPC G06F 40/166; G06N 10/20; G06N 10/60; G06F 40/242

(57) ABSTRACT

Systems and methods for quantum computing-based summarization are disclosed. A method for quantum computing-based summarization may include a classical computer program: receiving a document having a plurality of sentences; receiving a summary parameter that represents a subset of the plurality of sentences to include in a summary of the document; generating a vector for each sentence; calculating a centrality value for each vector; calculating a similarity value to other vectors for each vector; creating a cost function using the similarity values, the centrality values, a number of the plurality of sentences in the document, and the summary parameter; instructing a quantum computer to optimize the cost function using a quantum algorithm; receiving a dictionary comprising a plurality of distributions of the plurality of sentences and a probability for each distribution; and generating a summary comprising a subset of the plurality sentences based on a distribution having a highest probability.

### BACKGROUND OF THE INVENTION

### 1. Field of the Invention

Embodiments relate generally to systems and methods for quantum computing-based extractive summarization.

### 2. Description of the Related Art

Text summarization is a central application of Natural Language Processing (NLP). A summarization process takes a lengthy document and generates a shortened representation of it. Example implementations include summarizing news stories, parsing financial reports to produce a succinct executive summary, etc.

There are two procedurally distinct types of summarization—extractive summarization and abstractive summarization. Extractive summarization produces a summary by lifting sentences and phrases verbatim from the text. Abstractive summarization produces a summary by paraphrasing the text.

### SUMMARY OF THE INVENTION

Systems and methods for quantum computing-based extractive summarization are disclosed. According to one embodiment, a method for quantum computing-based extractive summarization may include: (1) receiving, by a classical computer program, a document having a plurality of sentences; (2) receiving, by the classical computer program, a summary parameter that represents a subset of the plurality of sentences to include in a summary of the document; (3) generating, by the classical computer program and for each of the plurality of sentences, a vector; (4) calculating, by the classical computer program and for each of the plurality of vectors, a centrality value; (5) calculating, by the classical computer program and for each of the plurality of vectors, a similarity value to other vectors; (6) creating, by the classical computer program, a cost function using the similarity values, the centrality values, a number of the plurality of sentences in the document, and the summary parameter; (7) instructing, by the classical computer program, a quantum computer to optimize the cost function using a quantum algorithm; (8) receiving, by the classical computer program and from the quantum computer, a dictionary comprising a plurality of distributions of the plurality of sentences and a probability for each distribution; and (9) generating, by the classical computer program, a summary comprising a subset of the plurality sentences based on a distribution having a highest probability.

In one embodiment, the method may also include receiving, by the classical computer program, a parameter gamma, and a parameter lambda, wherein the parameter gamma enforces the summary parameter, and the parameter lambda that balances the centrality value and the similarity value for the plurality of vectors, and the classical computer program creates the cost function using the parameter gamma and the parameter lambda.

In one embodiment, the quantum algorithm may optimize the cost function by maximizing the centrality value of the vectors while minimizing the similarity values between the vectors.

In one embodiment, the quantum algorithm may be a Quantum Approximate Optimization Algorithm, and the method may also include creating, by the classical computer program, a quantum circuit for the cost function, wherein the quantum circuit is an input to the Quantum Approximate Optimization Algorithm.

In one embodiment, the quantum algorithm may be a quantum annealing algorithm, and the cost function is an input to the quantum annealing algorithm.

In one embodiment, the classical computer program may instruct a first quantum computer to optimize the cost function using a first quantum algorithm, and a second quantum computer to optimize the cost function using a second quantum algorithm.

According to another embodiment, a system may include a classical computer comprising a memory storing a classical computer program and a computer processor. and a first quantum computer in communication with the classical computer. The classical computer program receives a document having a plurality of sentences; receives a summary parameter that represents a subset of the plurality of sentences to include in a summary of the document; generates, for each of the plurality of sentences, a vector; calculates, for each of the plurality of vectors, a centrality value; calculates, for each of the plurality of vectors, a similarity value to other vectors; creates a cost function using the similarity values, the centrality values, a number of the plurality of sentences in the document, and the summary parameter; instructs the first quantum computer to optimize the cost function using a quantum algorithm; receives, from the quantum computer, a dictionary comprising a plurality of distributions of the plurality of sentences and a probability for each distribution; and generates a summary comprising a subset of the plurality sentences based on a distribution having a highest probability. The first quantum computer optimizes the cost function using the quantum algorithm and returns the dictionary.

In one embodiment, the classical computer program receives a parameter gamma, and a parameter lambda, wherein the parameter gamma enforces the summary parameter, and the parameter lambda that balances the centrality value and the similarity value for the plurality of vectors, and the classical computer program creates the cost function using the parameter gamma and the parameter lambda.

In one embodiment, the quantum algorithm optimizes the cost function by maximizing the centrality value of the vectors while minimizing the similarity values between the vectors.

In one embodiment, the first quantum computer is a universal quantum computer, and the quantum algorithm comprises a Quantum Approximate Optimization Algorithm, and the classical computer program creates a quantum circuit for the cost function, wherein the quantum circuit is an input to the Quantum Approximate Optimization Algorithm.

In one embodiment, the first quantum computer comprises quantum annealing hardware, the quantum algorithm is a quantum annealing algorithm, and the cost function is an input to the quantum annealing algorithm.

In one embodiment, the system may further include a second quantum computer, and the classical computer program instructs the first quantum computer to optimize the cost function using a first quantum algorithm, and a second quantum computer to optimize the cost function using the second quantum algorithm. The first quantum computer may be a universal quantum computer, the first quantum algorithm may be a Quantum Approximate Optimization Algorithm, the second quantum computer may be quantum annealing hardware, and the second quantum algorithm may be a quantum annealing algorithm.

According to another embodiment, an electronic device may include a memory storing a classical computer program and a computer processor. When executed by the computer processor, the classical computer program may cause the computer processor to: receive a document having a plurality of sentences; receive a summary parameter that represents a subset of the plurality of sentences to include in a summary of the document; generate, for each of the plurality of sentences, a vector; calculate, for each of the plurality of vectors, a centrality value; calculates, for each of the plurality of vectors, a similarity value to other vectors; create a cost function using the similarity values, the centrality values, a number of the plurality of sentences in the document, and the summary parameter; instruct a quantum computer to optimize the cost function using a quantum algorithm; receive, from the quantum computer, a dictionary comprising a plurality of distributions of the plurality of sentences and a probability for each distribution; and generate a summary comprising a subset of the plurality sentences based on a distribution having a highest probability.

In one embodiment, the classical computer program may cause the computer processor to receive a parameter gamma, and a parameter lambda, wherein the parameter gamma enforces the summary parameter, and the parameter lambda that balances the centrality value and the similarity value for the plurality of vectors, and create the cost function using the parameter gamma and the parameter lambda.

In one embodiment, the quantum algorithm optimizes the cost function by maximizing the centrality value of the vectors while minimizing the similarity values between the vectors.

In one embodiment, the quantum algorithm may be a Quantum Approximate Optimization Algorithm, and the classical computer may cause the computer processor to create a quantum circuit for the cost function, wherein the quantum circuit is an input to the Quantum Approximate Optimization Algorithm.

In one embodiment, the quantum algorithm may be a quantum annealing algorithm, and the cost function is an input to the quantum annealing algorithm.

In one embodiment, the classical computer program may cause the computer processor to instruct a first quantum computer to optimize the cost function using a first quantum algorithm, and a second quantum computer to optimize the cost function using a second quantum algorithm.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for quantum computing-based extractive summarization according to one embodiment;

FIG. 2 depicts a method for quantum computing-based extractive summarization according to one embodiment.

### DETAILED DESCRIPTION OF PREFERRED EMBODIMENTS

Embodiments are directed to systems and methods for quantum computing-based extractive summarization.

Embodiments may involve classically mapping extractive text summarization to a quadratic optimization problem with the linear constraint of the number of sentences in the article or document out of the number of sentences in the article that are to be included in the summary. Embodiments may maximize the centrality value—a value that represents how central or important the sentence is to the document—so as to get a summary consisted of the most central sentences and to minimize the similarity value—how similar each sentence is to the other sentences in the summary—in order to avoid repetitions in the summary. In order to calculate the similarity and the centrality measures for each of the sentences in the article, vector representations of the sentences may be generated. An example of a suitable process is BERT sentence vectorization, described in Jacob Devlin et al. “Bert: Pre-training of deep bidirectional transformers for language understanding” arXiv preprint arXiv:1810.04805, 2018, the disclosure of which is hereby incorporated, by reference, in its entirety. Examples of measures of similarity include dot-product, cosine-similarity, etc., and examples of measures of centrality include TextRank, PageRank Term Frequency-Inverse Document Frequency (TF-IDF), etc.

The similarity value may be a pairwise similarity value, that is, the similarity value between pairs of sentences or vectors.

The summarization problem may be represented as an optimization problem as follows:

$${max}_{ℨ ∈ {\{ 0 , 1 \}}^{N}} {\sum }_{i = 0}^{N - 1} μ ( i ) {x}_{i} - λ {\sum }_{i = 0 , i \neq j}^{N - 1} β ( i , j ) {x}_{i} {x}_{j} - {Γ ( {\sum }_{i = 0}^{N - 1} {x}_{i} - M )}^{2}$$

N is the number of sentences in the article, and M is the number or sentences to be included in the summary. M is a subset of N.

The first term is the sum of the centrality values of the sentences in the summary while the second term is the sum of the pairwise similarity values of all the pairs of sentences in the summary (which is subtracted from the first term). The goal is to maximize this cost function by maximizing the centrality values of the sentences while minimizing the similarity values between the sentences in the summary (that is why there is a negative sign). The trade-off between centrality and similarity is measured by this parameter lambda (λ).

For example, for a sentence that has a very high centrality value and high pairwise similarity values with other sentences, the importance of similarity is given by the value of lambda. If the value of lambda is very high, the sentence will not be included. If the value of lambda is low, the sentence is included because it is very central and therefore prioritized. The value of lambda may be determined by the user.

The value gamma (Γ) is the Lagrange multiplier used to enforce the constraint of number of sentences in the summary. For example, a high value of gamma enforces the constraint on the number of sentences. In practice, the value of gamma should be that the last term in the cost function is of the same order than the other two terms together so as its “weight” in the cost function is high and it will be taken into account when the cost function is maximized.

In embodiments, the values for M, lambda, and gamma may be provided by the user. This cost function may also be cast as the problem of finding the ground state of a spin Hamiltonian by making the substitution xᵢ→(1−σ_{z}⁽ⁱ⁾)/2, where σ_{z}⁽ⁱ⁾ is the Pauli Z operator acting on the spin i.

Now that the problems have been re-formulated in this way, they are solved using a quantum computer. In both representations of the problem, each qubit in the machine represents a sentence. The maximization or optimization of the cost function is solved with quantum variational algorithms, whereas the finding of the ground state of a Hamiltonian is solved using quantum annealing. In both cases, the input of the algorithm are the N sentences of the article and the output is a summary containing M sentences.

Although embodiments may be described using particular quantum approaches, it should be recognized that the invention is not so limited. Embodiments may formulate the problem as a cost function and then optimize this cost function using any suitable quantum computing algorithm.

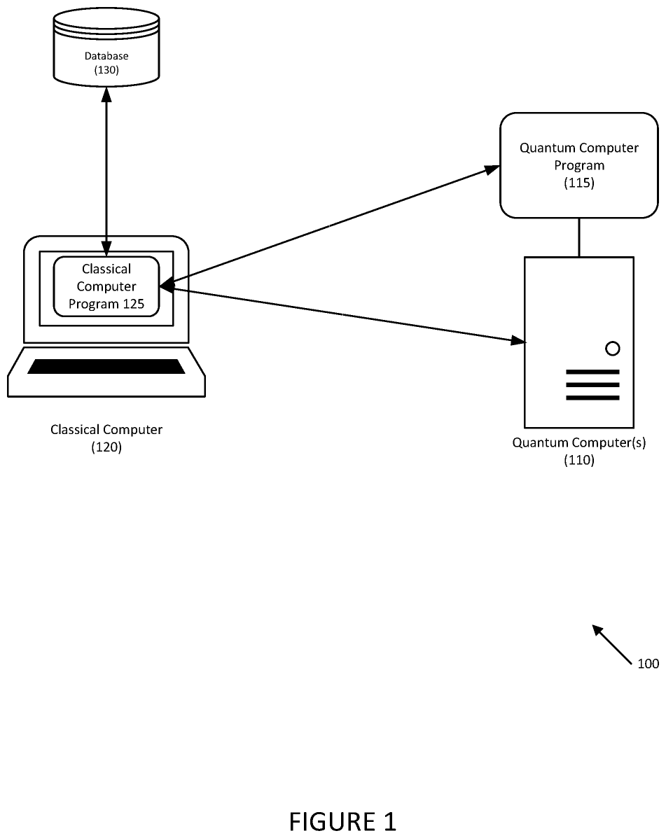

Referring to FIG. 1, a system for quantum computing-based extractive summarization is disclosed according to an embodiment. System 100 may include quantum computer 110 that may execute quantum computer program 115. Classical computer 120 may interface with quantum computer program 115 using classical computer program 125. Classical computer 120 may be any suitable classical computing device, including servers, workstations, desktop, notebook, laptop, or tablet computers, etc.

A plurality of quantum computers 110 may be used. For example, a first quantum computer may be a universal quantum computer that may execute a Quantum Approximate Optimization Algorithm (QAOA), and a second quantum computer may be quantum annealing hardware to execute a quantum annealing algorithm. In one embodiment, quantum computer program 115 may be an algorithm, such as QAOA or quantum annealing.

An example of QAOA is given in provided in Farhi, E., Goldstone, J. & Gutmann, S. (2014) “A quantum approximate optimization algorithm,” arXiv preprint arXiv:1411.4028, the disclosure of which is incorporated, by reference, in its entirety.

An example of Quantum Annealing is given in Farhi, E., Goldstone, J., Gutmann, S., & Sipser, M. (2000) “Quantum computation by adiabatic evolution,” arXiv preprint quant-ph/0001106., the disclosure of which is incorporated, by reference, in its entirety.

Other algorithms may be used as is necessary and/or desired.

In one embodiment, the universal quantum computer and/or the quantum annealing hardware may be used.

Classical computer program 125 may provide input to, and receive output from, one or more quantum computers 110 and/or quantum computer program 115. In one embodiment, classical computer program 125 may generate one or more quantum computer programs 115, such as one or more quantum circuits, and may provide one or more quantum computer programs 115 to quantum computer 110. Classical computer program 125 may receive the results of the execution of the one or more quantum computer programs 115.

Database 130 may be a source of data, such as articles, documents, etc. For example, the input data may be an article as well as a parameter specifying the length of the summary to be generated.

In one embodiment, classical computer program 125 may create one or more quantum circuits that implements at least portions of a quantum computing-based extractive summarization. Classical computer program 125 may then transpile the quantum circuit(s) and may then send the transpiled circuit(s) to the quantum computer for execution. Classical computer program 125 may receive the results from quantum computer(s) 110.

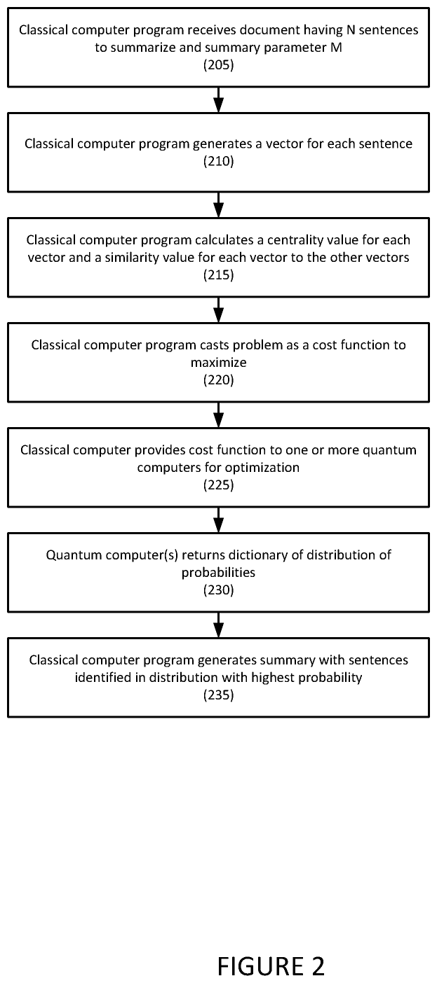

Referring to FIG. 2, a method for quantum computing-based extractive summarization is disclosed according to an embodiment. In step 205, a classical computer program may receive a document or article having N sentences to summarize. The classical computer program may further receive a summary parameter M, which represents the number of sentences to include in the summary, a value for lambda, and a value for gamma

In step 210, the classical computer program may generate a vector for each sentence in the document or article. In one embodiment, BERT may be used to generate the vectors. In another embodiment, TF-IDF may be used to calculate vectors. Other techniques may be used as is necessary and/or desired.

In step 215, the classical computer program may calculate a centrality value for each vector, as well as the pair-wise similarity value for each pair of vectors. For example, TextRank, PageRank, rankings based on TF-IDF, etc. may be used to calculate the centrality values, and dot-product, cosine-similarity, etc. may be used to calculate the similarity value.

In step 220, the classical computer program may cast the problem as a cost function that has to be maximized so as to maximize centrality values and minimize similarity values using, for example, the following:

$${max}_{ℨ ∈ {\{ 0 , 1 \}}^{N}} {\sum }_{i = 0}^{N - 1} μ ( i ) {x}_{i} - λ {\sum }_{i = 0 , i \neq j}^{N - 1} β ( i , j ) {x}_{i} {x}_{j} - {Γ ( {\sum }_{i = 0}^{N - 1} {x}_{i} - M )}^{2}$$

The binary variable xᵢ represents whether the sentence i is in the summary or not.

In step 225, the classical computer program may provide the cost function to one or more quantum computers for optimization. For example, the classical computer program may select the quantum algorithm to use (e.g., QAOA, quantum annealing, or both) to optimize the cost function, and then send the cost function to the appropriate quantum computers.

In one embodiment, selection of the quantum algorithm to use may be received as a parameter. In another embodiment, the classical computer program may select the quantum algorithm to use based on past performance of the quantum algorithms. In another embodiment, the classical computer program may use both quantum algorithms and return the results of both.

In one embodiment, the classical computer program may select QAOA and may create a quantum circuit that optimizes the cost function that is passed as an input to the QAOA. QAOA is an iterative algorithm and in each iteration, a different quantum circuit is made and executed. After each iteration, the quantum computer sends the answer to the classical computer program and based on that, the classical computer program generates the next circuit to be executed and then it is sent to the quantum computer to execute. The process continues until a convergence is reached.

In one embodiment, the classical computer program may select a quantum annealing algorithm and may provide the cost function to quantum annealing hardware as an input to a quantum annealing algorithm.

In one embodiment, the classical computer program may select both algorithms and send the cost function to both quantum computers. The classical computer program may receive results from each quantum computer.

The quantum computer(s) may return a distribution of probability of the binary state the maximizes the most the cost function.

In step 230, the quantum computer program may return a dictionary that identifies a distribution of the sentences to include in summary and a probability for each distribution. For example, each sentence may be assigned a value 0 or 1, which may indicate whether the sentence should be included or not included in the summary. The dictionary may be {‘11001’: 90%; ‘10010’: 5%, etc.}. The classical computer program may select the distribution with the highest probability, in this case the distribution ‘11001’ has a 90% probability, which indicates that the first, second and last sentences should be included in the summary.

In step 235, the classical computer program may generate a summary with the identified M sentences and may output the summary.

An example of the process is as follows. A document contains five sentences, and the user wishes to select three of the five sentences for a summary. The classical computer program may generate a vector for each of the five sentences, and then the centrality value and the pairwise similarity value for each vector. Using the lambda value and the gamma value, the classical computer program may create the cost function to optimize the centrality values and minimize the similarity values of the vectors to include in the summary. The classical computer program then generates a quantum circuit for the cost function and instructs one or more quantum computer to optimize the cost function. The quantum computer returns a dictionary such as {‘11001’: 90%, ‘00111’: 10%}. Using the dictionary, the classical computer the first, second and last sentences for the summary, and returns a summary with those sentences.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

In one embodiment, the processing machine may be a classical computer, a quantum computer, etc.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, a memory stick, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user.

Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for quantum computing-based extractive summarization, comprising:
receiving, by a classical computer program, a document having a plurality of sentences;
receiving, by the classical computer program, a summary parameter that represents a subset of the plurality of sentences to include in a summary of the document;
generating, by the classical computer program and for each of the plurality of sentences, a vector;
calculating, by the classical computer program and for each of the plurality of vectors, a centrality value;
calculating, by the classical computer program and for each of the plurality of vectors, a similarity value to other vectors;
receiving, by the classical computer program, a parameter gamma, and a parameter lambda, wherein the parameter gamma enforces the summary parameter, and the parameter lambda that balances the centrality value and the similarity value for the plurality of vectors;
creating, by the classical computer program, a cost function using the similarity values, the centrality values, a number of the plurality of sentences in the document, the summary parameter. the parameter gamma and the parameter lambda;
instructing, by the classical computer program, a quantum computer to optimize the cost function using a quantum algorithm;
receiving, by the classical computer program and from the quantum computer, a dictionary comprising a plurality of distributions of the plurality of sentences and a probability for each distribution; and
generating, by the classical computer program, a summary comprising a subset of the plurality sentences based on a distribution having a highest probability.

2. (canceled)

3. The method of claim 1, wherein the quantum algorithm optimizes the cost function by maximizing the centrality value of the vectors while minimizing the similarity values between the vectors.

4. The method of claim 1, wherein the quantum algorithm comprises a Quantum Approximate Optimization Algorithm, and further comprising:
creating, by the classical computer program, a quantum circuit for the cost function, wherein the quantum circuit is an input to the Quantum Approximate Optimization Algorithm.

5. The method of claim 1, wherein the quantum algorithm is a quantum annealing algorithm, and the cost function is an input to the quantum annealing algorithm.

6. The method of claim 1, wherein the classical computer program instructs a first quantum computer to optimize the cost function using a first quantum algorithm, and a second quantum computer to optimize the cost function using a second quantum algorithm.

7. A system, comprising:
a classical computer comprising a memory storing a classical computer program and a computer processor; and
a first quantum computer in communication with the classical computer;
wherein the classical computer program receives a document having a plurality of sentences; receives a summary parameter that represents a subset of the plurality of sentences to include in a summary of the document; generates, for each of the plurality of sentences, a vector; calculates, for each of the plurality of vectors, a centrality value; calculates, for each of the plurality of vectors, a similarity value to other vectors; receives a parameter gamma, and a parameter lambda, wherein the parameter gamma enforces the summary parameter, and the parameter lambda that balances the centrality value and the similarity value for the plurality of vectors; creates a cost function using the similarity values, the centrality values, a number of the plurality of sentences in the document, the summary parameter. the parameter gamma and the parameter lambda; instructs the first quantum computer to optimize the cost function using a quantum algorithm; receives, from the quantum computer, a dictionary comprising a plurality of distributions of the plurality of sentences and a probability for each distribution; and generates a summary comprising a subset of the plurality sentences based on a distribution having a highest probability; and
wherein the first quantum computer optimizes the cost function using the quantum algorithm and returns the dictionary.

8. (canceled)

9. The system of claim 7, wherein the quantum algorithm optimizes the cost function by maximizing the centrality value of the vectors while minimizing the similarity values between the vectors.

10. The system of claim 7, wherein the first quantum computer is a universal quantum computer, and the quantum algorithm comprises a Quantum Approximate Optimization Algorithm, and the classical computer program creates a quantum circuit for the cost function, wherein the quantum circuit is an input to the Quantum Approximate Optimization Algorithm.

11. The system of claim 7, wherein the first quantum computer comprises quantum annealing hardware, the quantum algorithm is a quantum annealing algorithm, and the cost function is an input to the quantum annealing algorithm.

12. The system of claim 7, further comprising a second quantum computer, and the classical computer program instructs the first quantum computer to optimize the cost function using a first quantum algorithm, and a second quantum computer to optimize the cost function using a second quantum algorithm.

13. The system of claim 12, wherein the first quantum computer comprises a universal quantum computer, the first quantum algorithm comprises a Quantum Approximate Optimization Algorithm, the second quantum computer comprises quantum annealing hardware, and the second quantum algorithm comprises a quantum annealing algorithm.

14. An electronic device, comprising:
a memory storing a classical computer program; and
a computer processor;
wherein, when executed by the computer processor, the classical computer program causes the computer processor to:
receive a document having a plurality of sentences;
receive a summary parameter that represents a subset of the plurality of sentences to include in a summary of the document;
generate, for each of the plurality of sentences, a vector;
calculate, for each of the plurality of vectors, a centrality value;
calculates, for each of the plurality of vectors, a similarity value to other vectors;
receive a parameter gamma, and a parameter lambda, wherein the parameter gamma enforces the summary parameter, and the parameter lambda that balances the centrality value and the similarity value for the plurality of vectors;
create a cost function using the similarity values, the centrality values, a number of the plurality of sentences in the document, the summary parameter. the parameter gamma and the parameter lambda;
instruct a quantum computer to optimize the cost function using a quantum algorithm;
receive, from the quantum computer, a dictionary comprising a plurality of distributions of the plurality of sentences and a probability for each distribution; and
generate a summary comprising a subset of the plurality sentences based on a distribution having a highest probability.

15. (canceled)

16. The electronic device of claim 14, wherein the quantum algorithm optimizes the cost function by maximizing the centrality value of the vectors while minimizing the similarity values between the vectors.

17. The electronic device of claim 14, wherein the quantum algorithm comprises a Quantum Approximate Optimization Algorithm, and the classical computer causes the computer processor to create a quantum circuit for the cost function, wherein the quantum circuit is an input to the Quantum Approximate Optimization Algorithm.

18. The electronic device of claim 14, wherein the quantum algorithm is a quantum annealing algorithm, and the cost function is an input to the quantum annealing algorithm.

19. The electronic device of claim 14, wherein the classical computer program causes the computer processor to instruct a first quantum computer to optimize the cost function using a first quantum algorithm, and a second quantum computer to optimize the cost function using a second quantum algorithm.
